(19) United States
(12) Patent Application Publication
(10) Pub. No.: US 2018/0210500 A1
(43) Pub. Date: Jul. 26, 2018

(54) COVER FOR A COMPUTING DEVICE

(71) Applicant: HEWLETT-PACKARD DEVELOPMENT COMPANY, L.P., HOUSTON, TX (US)

(72) Inventors: MICHAEL DELPIER, HOUSTON, TX (US); DUSTIN HOFFMAN, HOUSTON, TX (US)

(21) Appl. No.: 15/746,106

(22) PCT Filed: Sep. 2, 2015
(86) PCT No.: PCT/US2015/048151

§ 371 Date: Jan. 19, 2018

(51) Int. Cl. G06F 1/16

(52) U.S. Cl. CPC G06F 1/1626; G06F 2200/1633

(57) ABSTRACT

Examples disclosed herein provide a cover for a computing device. The cover can include a first set of segments having a first durometer, and a second set of segments having a second durometer lower than the first durometer. As an example, segments from the second set are disposed between segments from the first set, and are flush with the first set of segments.

### BACKGROUND

The emergence and popularity of mobile computing has made portable computing devices, due to their compact design and light weight, a staple in today's marketplace. Smartphones, tablets, and notebooks are examples of portable computing devices that are widely used. Such devices may employ a touchscreen on a display surface of the device that may be used for both viewing and input. Users of such devices may interact with the touchscreen via finger or stylus gestures.

### BRIEF DESCRIPTION OF THE DRAWINGS

FIGS. 1A-B illustrate a cover for a computing device, according to an example; and

FIGS. 2A-B illustrate a system including a protective cover and a computing device, according to an example.

### DETAILED DESCRIPTION

While using a portable computing device such as a smartphone, tablet, or notebook, it may be desirable to protect the computing device via a protective cover. As an example, the protective cover may prevent damage to the computing device from accidental drops. The protective cover may be used to cover various portions of the computing device, such as the display surface and/or the back surface opposite the display surface. As an example, the protective cover may protect at least the display surface when the computing device is not in use. When designing such protective covers, factors that may be considered include at least aesthetics and ease of use.

Examples disclosed herein provide a protective cover for a portable computing device, such as a smartphone, tablet, or notebook. As will be further described, the protective cover generally includes a first set of segments having a first durometer, and a second set of segments having a second durometer lower than the first durometer. Segments from the second set may be disposed between segments from the first set, and be flush with the first set. As an example, the protective cover is foldable along the segments from the second set. The width of the segments from the second set may contribute to the usability of the computing device, as will be further described. In addition, with the first and second sets being flush with respect to each other, the chances of a surface of the cover inadvertently getting caught on another surface is reduced.

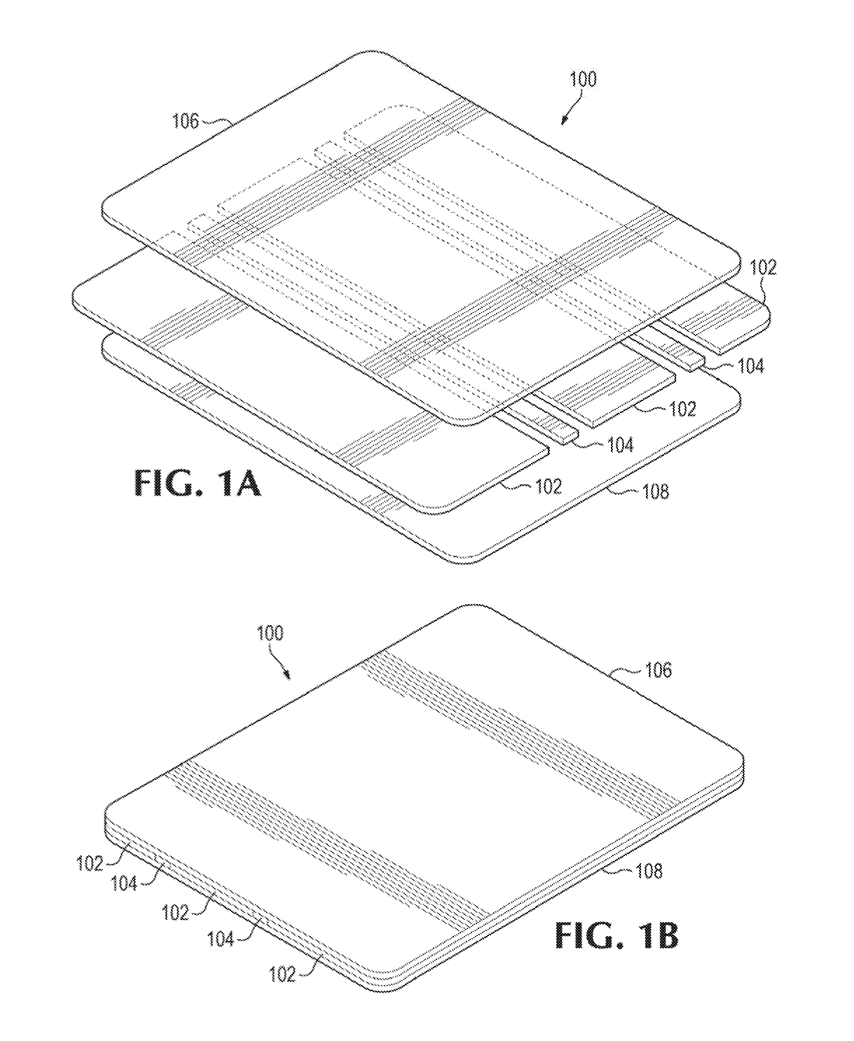

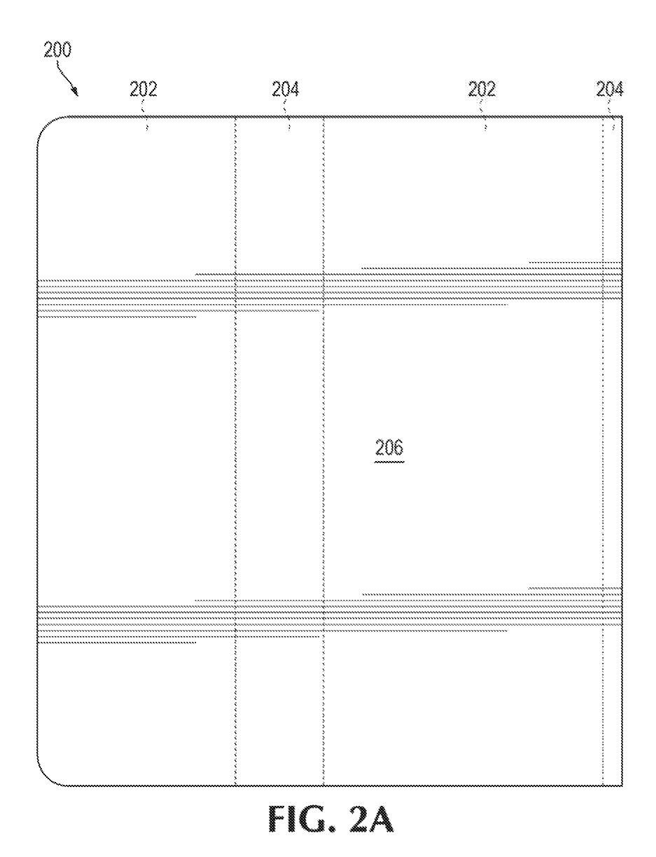

With reference to the figures, FIGS. 1A-B illustrate a cover 100 for a computing device, according to an example. FIG. 1A illustrates an exploded view of the cover 100 and its components, and FIG. 1B illustrates an assembled view of the cover 100. As mentioned above, the cover 100 may be used to cover various portions of the computing device, such as the display surface or the back surface opposite the display surface. As an example, the cover 100 may prevent damage to the computing device from accidental drops.

As illustrated, the cover 100 includes a first set of segments 102 having a first durometer, and a second set of segments 104 having a second durometer lower than the first durometer. As an example, the first set of segments 102 may correspond to rigid materials, and the second set of segments 104 may correspond to flexible materials (e.g., having a lower durometer than the rigid materials), allowing for the cover 100 to bendable along the flexible materials. As an example, the cover 100 may include three segments 102 from the first set and two segments 104 from the second set, as illustrated. However, the number of segments 102, 104 from each set may vary. For example, the cover 100 may include only two segments 102 from the first set, and a single segment 104 from the second set disposed between the two segments 102 from the first set, allowing for the two segments 102 from the first set to be folded with respect to each other.

As mentioned above, segments 102 from the first set may be composed of a rigid or semi-rigid material in order to provide a level of sturdiness and rigidity while using the cover 100 with a computing device. In addition, the rigid materials may provide an extra layer of protection for the computing device. Examples of materials that may be used for the segments 102 from the first set include, but are not limited to, plastics, fiber glass, carbon fiber composites, and metals.

Each segment 102 from the first set may be separated from other segments 102 from the first set by segments 104 from the second set, which is composed of foldable or pliable material. As an example, the segments 104 from the second set are composed of elastomeric materials that have a lower durometer than the rigid or semi-rigid materials of the segments 102 from the first set. The thickness of the segments 104 from the second set may match or be similar to the thickness of the segments 102 from the first set, thereby allowing for the cover 100 to have a flush appearance. As an example, the second set of segments 104 are flush with the first set of segments 102, as illustrated in FIG. 1B.

By having segments 104 from the second set as thick as the segments 102 from the first set, the segments 104 of the cover 100 may provide a greater amount of shock absorption, for example, from accidental drops, compared to thinner or no materials between the segments 102 from the first set. Another advantage of having the second set of segments 104 flush with the first set of segments 102 is the reduced chance of the cover 100 inadvertently getting caught on another surface. For example, when the computing device coupled with the cover 100 is being slid into a book bag or purse, it is less likely for the cover 100 to catch on other objects, particularly due to the flush surface of the cover 100. In, the flush appearance of the cover 100 provides a cleaner aesthetic for a more appealing product.

Referring to FIGS. 1A-B, the cover 100 may include a first covering 106 and/or a second covering 108. For example, the first covering 106 may cover a top flush surface of the first and second sets of segments 102, 104. Similarly, the second covering 108 may cover a bottom flush surface of the first and second sets of segments 102, 104 opposite the top flush surface. However, the use of the first or second coverings 106, 108 may not be required, particularly as flush surfaces are already provided via the combination of the first and second sets of segments 102, 104.

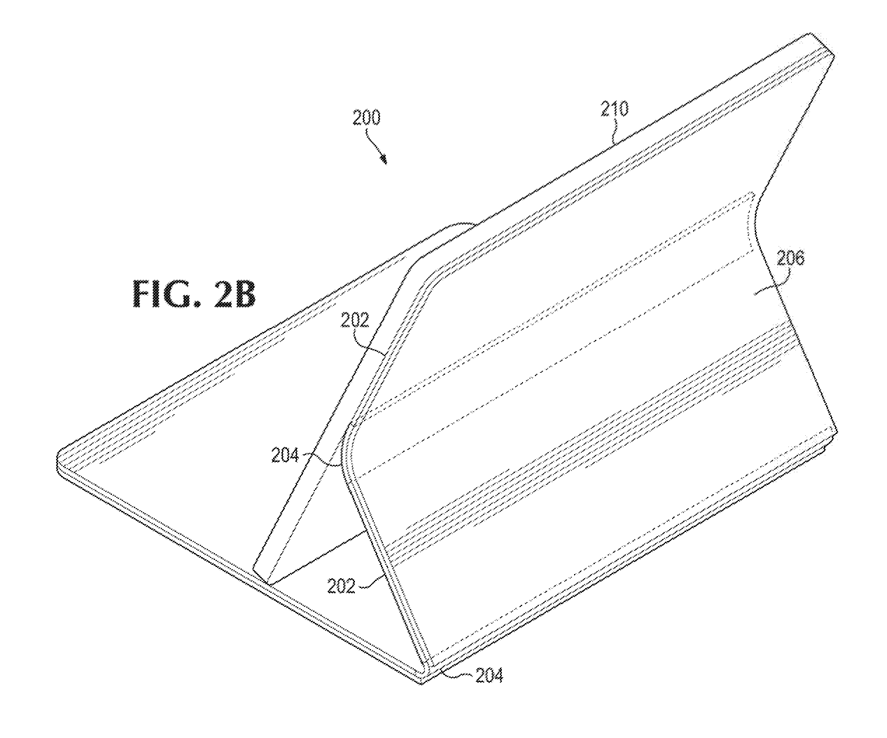

FIGS. 2A-B illustrate a system including a protective cover 200 and a computing device 210, according to an example. Similar to cover 100 from FIGS. 1A-B, cover 200 may be used to cover various portions of the computing device 210, such as the display surface or the back surface opposite the display surface. As illustrated, the cover 200 includes a first set of segments 202 having a first durometer, and a second set of segments 204 having a second durometer lower than the first durometer. As will be further described, the first set of segments 202 may correspond to rigid materials, and the second set of segments 204 may correspond to flexible materials (e.g., having a lower durometer than the rigid materials), allowing for the cover 200 to bendable along the flexible materials. As illustrated in FIG. 2B, the cover 200 is bendable along the second set of segments 204.

As an example, segments 202 from the first set may be composed of a rigid or semi-rigid material in order to provide a level of sturdiness and rigidity while using the cover 200 with the computing device 210. In addition, the rigid materials may provide an extra layer of protection for the computing device 210. Examples of materials that may be used for the segments 202 from the first set include, but are not limited to, plastics, fiber glass, carbon fiber composites, and metals.

Each segment 202 from the first set may be separated from other segments 202 from the first set by segments 204 from the second set, which is composed of foldable or pliable material. As an example, the segments 204 from the second set are composed of elastomeric materials that have a lower durometer than the rigid or semi-rigid materials of the segments 202 from the first set. The thickness of the segments 204 from the second set may match or be similar to the thickness of the segments 202 from the first set, thereby allowing for the cover 200 to have a flush appearance. As an example, the second set of segments 204 are flush with the first set of segments 202, as illustrated in FIG. 2B.

As an example, the width of each segment 204 from second set varies with respect to each other. For example, referring to FIG. 2B, the width of the upper segment 204, near the midsection of the computing device 210, may be wider than the width of the lower segment 204, for closing the computing device 210 within the cover 200 (e.g., a folio cover). As a result, by being able to increase the width of certain segments 204, softer curvatures may be provided. Referring to the upper segment 204, which has a wider width, for example, to the lower segment 204, the bounce factor, while using touch on the display surface of the computing device 210, may be improved. In addition to having various widths, each segment 204 from the second set may have varying durometers, all lower than the durometer of the rigid or semi-rigid segments 202. This is particularly useful when the bendability of each segment 204 may have to vary.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A cover for a computing device, the cover comprising:
a first set of segments having a first durometer; and
a second set of segments having a second durometer lower than the first durometer, wherein segments from the second set are disposed between segments from the first set, and wherein the second set of segments are flush with the first set of segments.

2. The cover of claim 1, wherein each segment from the second set have varying durometers, all lower than the first durometer.

3. The cover of claim 1, comprising:
a first covering to cover a top flush surface of the first and second sets of segments.

4. The cover of claim 3, comprising:
a second covering to cover a bottom flush surface of the first and second sets of segments opposite the top flush surface.

5. The cover of claim 1, wherein a width of each segment from the second set varies with respect to each other.

6. The cover of claim 1, wherein by the second set of segments having a thickness similar to the first set of segments, the second set of segments is to provide shock absorption to protect the computing device.

7. A cover for a computing device, the cover comprising:
rigid segments having a first durometer; and
elastomeric segments disposed between the rigid segments, wherein the elastomeric segments have a second durometer lower than the first durometer and have a thickness similar to the rigid segments.

8. The cover of claim 7, wherein each elastomeric segment have varying durometers, all lower than the first durometer.

9. The cover of claim 7, comprising:
a first covering to cover a top flush surface of the rigid and elastomeric segments.

10. The cover of claim 9, comprising:
a second covering to cover a bottom flush surface of the rigid and elastomeric segments opposite the top flush surface.

11. The cover of claim 7, wherein a width of each segment from the elastomeric segments varies with respect to each other.

12. The cover of claim 7, wherein by the elastomeric segments having a thickness similar to the rigid segments, the elastomeric segments are to provide shock absorption to protect the computing device.

13. A system comprising:
a computing device including a display surface and a back surface opposite the display surface; and
a cover for the computing device, the cover comprising:
a first set of segments having a first durometer; and
a second set of segments having a second durometer lower than the first durometer, wherein segments from the second set are disposed between segments from the first set, and wherein the second set of segments have a thickness similar to the first set of segments.

14. The system of claim 13, wherein each segment from the second set have varying durometers, all lower than the first durometer.

15. The system of claim 13, wherein a width of each segment from the second set varies with respect to each other.
